(19) United States
(12) Patent Application Publication
(10) Pub. No.: US 2022/0320970 A1
(43) Pub. Date: Oct. 6, 2022

(54) STATOR UNIT AND MOTOR

(71) Applicant: NIDEC CORPORATION, Kyoto (JP)

(72) Inventors: Hibiki TAKADA, Kyoto (JP); Takahiro HIWA, Kyoto (JP)

(21) Appl. No.: 17/616,189

(22) PCT Filed: May 27, 2020
(86) PCT No.: PCT/JP2020/021005

§ 371 Date: Dec. 3, 2021

(30) Foreign Application Priority Data
Jun. 6, 2019 (JP) 2019-106507

(51) Int. Cl. H02K 11/25; H02K 3/50

(52) U.S. Cl. CPC H02K 11/25; H02K 3/50; H02K 2203/09

(57) ABSTRACT

A stator unit includes: a stator core; three-phase coils inserted into slots of the stator core; a neutral point busbar connected to the three-phase coils; a busbar holder made of a resin material and covering at least a part of the neutral point busbar; and a temperature sensor that is fixed to the busbar holder while in contact with the neutral point busbar, the temperature sensor measuring the temperature of the neutral point busbar.

### CROSS-REFERENCE TO RELATED APPLICATIONS

This is the U.S. national stage of application No. PCT/JP2020/021005, filed on May 27, 2020, and priority under 35 U.S.C. § 119(a) and 35 U.S.C. § 365(b) is claimed from Japanese Patent Application No. 2019-106507, filed on Jun. 6, 2019.

### FIELD OF THE INVENTION

The present invention relates to a stator unit and a motor. The present invention claims priority based on Japanese Patent Application No. 2019-106507 filed in Japan on Jun. 6, 2019, the contents of which are incorporated herein by reference.

### BACKGROUND

A stator unit including a temperature sensor that measures the temperature of a busbar connected to a coil is known. As such a stator unit, a stator of a rotary electric machine is known, the stator including a neutral line having a U-shaped portion which is connected to a neutral point of a stator coil and is bent in a U shape, and a temperature sensor that detects the temperature of the neutral line, for example.

The temperature sensor includes: a main body portion that has a thermistor element embedded therein and that is engaged with the U-shaped portion of the neutral line; and arm portions extending from the main body portion so as to hold legs of the U-shaped portion, respectively. Each of the arm portions has elasticity and is attachable to and detachable from the U-shaped portion.

In the stator described above, the neutral line is curved in a U shape, and the temperature sensor is positioned within the neutral line curved in a U shape. In the configuration described above, it is necessary to perform processing to curve the neutral line in a U shape with high accuracy. Such processing of the neutral line is difficult, and thus, it is difficult to improve the productivity of the stator.

In the stator described above, the temperature sensor is disposed within the neutral line curved in a U shape. Therefore, the direction in which a wire of the temperature sensor is extracted is limited, and the arrangement of the temperature sensor is also limited.

### SUMMARY

An exemplary stator unit according to the present invention includes: a stator core that is cylindrical and has a plurality of slots arranged in a circumferential direction on an inner peripheral surface or an outer peripheral surface; a plurality of coils inserted into the slots; a plurality of busbars connected to the plurality of coils; a resin portion made of a resin material and covering at least a part of the plurality of busbars; and a temperature sensor that is fixed to the resin portion while in contact with at least one busbar among the plurality of busbars, the temperature sensor measuring a temperature of the at least one busbar.

An exemplary motor according to the present invention includes the abovementioned stator unit, and a rotor rotatable about a central axis with respect to a stator of the stator unit.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a diagram illustrating a schematic configuration of a motor including a stator unit according to a first embodiment;

FIG. 2 is a perspective view illustrating a schematic configuration of the stator unit;

FIG. 3 is a perspective view illustrating a schematic configuration of the stator unit from which a busbar holder and a wire accommodation portion are removed;

FIG. 4 is a perspective view schematically illustrating a positional relationship between a stator core and coils;

FIG. 5 is a perspective view illustrating a schematic configuration of a busbar unit from which the busbar holder, the wire accommodation portion, and an external terminal cover are removed;

FIG. 6 is a perspective view illustrating a schematic configuration of the stator unit from which a cover of the wire accommodation portion is removed;

FIG. 7 is a partially enlarged view illustrating a part of FIG. 6 in an enlarged manner; and

FIG. 8 is a perspective view schematically illustrating a positional relationship between busbars of a stator unit and a temperature sensor according to a second embodiment.

### DETAILED DESCRIPTION

Embodiments of the present invention will be described below in detail with reference to the drawings. The same or corresponding parts in the drawings are denoted by the same reference numerals, and the description thereof will not be repeated. The constituent members in the drawings are not limited to have the dimensions and the dimensional ratios illustrated in the drawings.

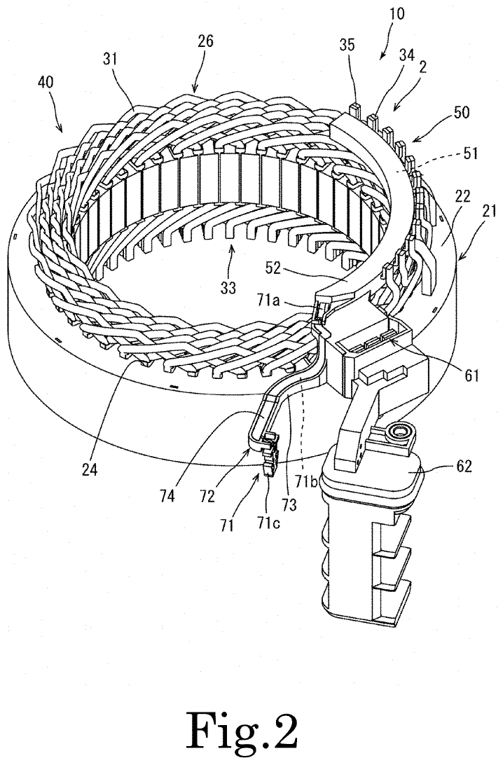

In the following description, a direction parallel to a central axis of a stator is referred to as an “axial direction”, a direction perpendicular to the central axis is referred to by the term “radial direction” or “radially”, and a direction along an arc around the central axis is referred to as a “circumferential direction”. In addition, regarding the axial direction, a side where a busbar is located with respect to the stator is referred to as a “first side”, and a side opposite to the side where the busbar is located with respect to the stator is referred to as a “second side”. That is, in the present specification, an upper side is the “first side”, and a lower side is the “second side” in FIG. 2. However, there is no intention to limit the direction at the time of using a motor according to the present invention by the definitions of the directions.

Further, in the following description, expressions such as “fixed”, “connected”, and “attached” (hereinafter, fixed, etc.) are used not only when the members are directly fixed to each other, but also when the members are fixed via another member. That is, in the following description, the expression such as “fixed” includes the meaning indicating that the members are directly fixed and the members are indirectly fixed.

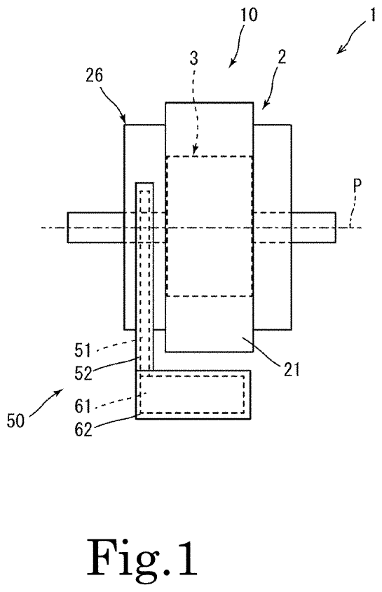

FIG. 1 shows a schematic configuration of a motor 1 according to the first embodiment of the present invention. The motor 1 includes a stator unit 10 and a rotor 3. The stator unit 10 includes a stator 2 and a busbar unit 50. The rotor 3 rotates about a central axis P with respect to the stator 2. That is, the motor 1 has the stator 2 and the rotor 3 that is rotatable with respect to the stator 2.

In the present embodiment, the motor 1 is a so-called inner rotor type motor in which the rotor 3 is located so as to be rotatable about the central axis P in the tubular stator 2. The rotor 3 includes a plurality of magnets arranged in the circumferential direction around the central axis P. Since the configuration of the rotor 3 is similar to that of a typical rotor, the detailed description of the rotor 3 will be omitted.

The stator 2 includes a stator core 21 and coils 26. In FIG. 1, the coils 26 are illustrated in a simplified manner for the sake of description. Power is supplied to the coils 26 via busbars 51 and external terminals 61 of the busbar unit 50 described later. In the present embodiment, the coils 26 include three-phase coils 26u, 26v, and 26w as described later.

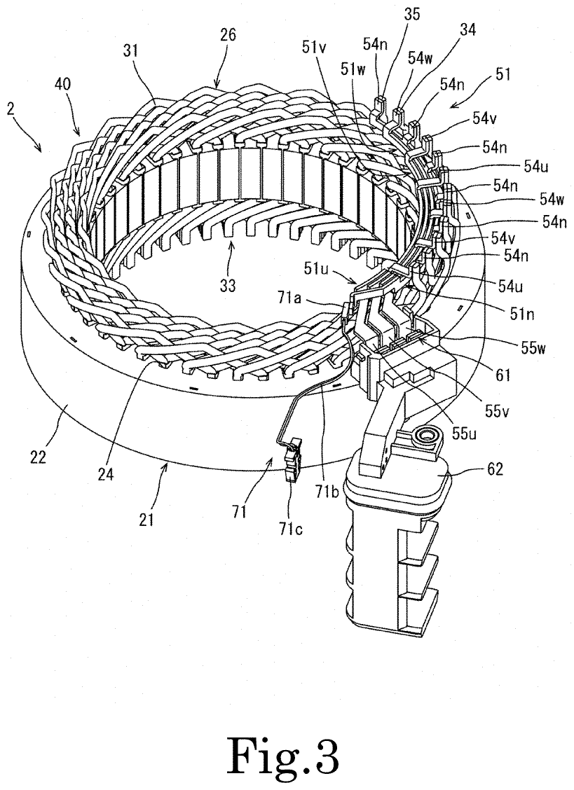

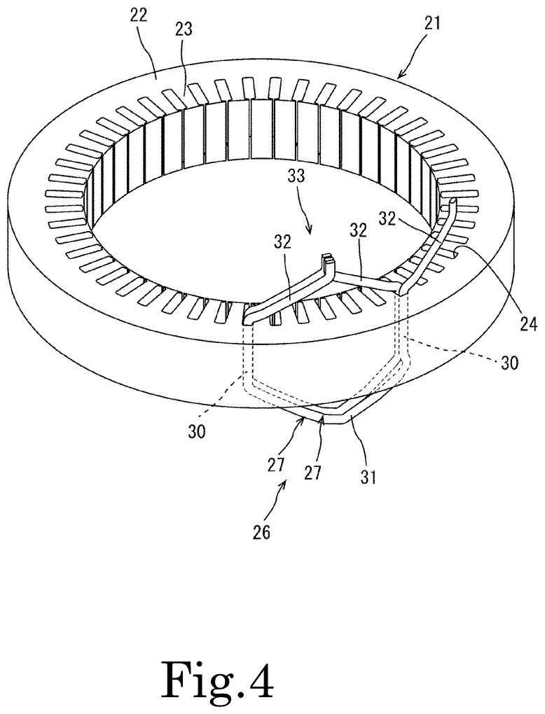

FIG. 2 is a perspective view of the stator unit 10 of the motor 1 according to the present embodiment. FIG. 3 is a diagram illustrating a state in which a busbar holder 52 and a wire accommodation portion 72 of the busbar unit 50 are removed from the stator unit 10 illustrated in FIG. 2. FIG. 4 is a perspective view schematically illustrating an example of a positional relationship between the stator core 21 and the coils 26. FIG. 4 only illustrates a part of the coils 26 located in slots 24 of the stator core 21 for the sake of description. FIG. 4 is a diagram of the stator core 21 and the coils 26 when viewed from the side opposite to the side in other drawings in the axial direction, for the sake of description. That is, FIG. 4 is a diagram of the stator core 21 and the coils 26 when viewed from the second side in the axial direction.

The stator core 21 has a cylindrical shape extending in the axial direction. The stator core 21 is obtained by stacking a plurality of electromagnetic steel sheets formed in a predetermined shape in the thickness direction.

As illustrated in FIG. 4, the stator core 21 includes a cylindrical yoke 22, a plurality of teeth 23 extending inward from the yoke 22 in the radial direction, and the slots 24. In the present embodiment, the stator core 21 is a cylindrical round core. The yoke 22 and the plurality of teeth 23 are integrally formed as a single member. The stator core 21 may be, for example, a split core or a straight core.

As illustrated in FIG. 4, the plurality of teeth 23 is arranged at equal intervals in the circumferential direction. Each of the teeth 23 extends from one end to the other end of the stator core 21 in the axial direction. The slot 24 is located between adjacent teeth 23 among the plurality of teeth 23. The slot 24 is a groove extending in the axial direction in the stator core 21. The slot 24 extends along the central axis P. The stator core 21 has a plurality of slots 24 arranged in the circumferential direction on the inner peripheral surface. As will be described later, a plurality of coils 26 is inserted into the plurality of slots 24.

In the present embodiment, the coils 26 include a U-phase coil 26u, a V-phase coil 26v, and a W-phase coil 26w. The coils 26 are wound around the plurality of teeth 23 in a distributed winding, and are Y-connected by the four busbars 51. In the present embodiment, the coils 26 include two sets of U-phase coils 26u, V-phase coils 26v, and W-phase coils 26w. In the following description and drawings, when it is necessary to distinguish the phases of the respective components, u, v, w, and n indicating the U phase, the V phase, the W phase, and the neutral point are added to the end of the reference numerals of the respective components.

In each of the U-phase coil 26u, the V-phase coil 26v, and the W-phase coil 26w, multiple segment coils 27 are connected in series. Each segment coil 27 has a rectangular cross-sectional shape and is constituted by a bent rectangular wire. The segment coil 27 may have a cross section having a shape other than a rectangle.

As illustrated in FIGS. 2 to 4, each segment coil 27 includes a pair of linear slot accommodation portions 30 located in the slots 24, a segment coil connection portion 31 connecting the pair of slot accommodation portions 30, and a pair of segment coil end portions 32 which are ends of the segment coil 27. The plurality of segment coils may include a segment coil having a linear slot accommodation portion and segment coil end portions located at both ends of the slot accommodation portion.

The slot accommodation portions 30 of the plurality of segment coils 27 are accommodated in the slots 24 while being overlapped in the radial direction. The segment coil connection portions 31 of the plurality of segment coils 27 are positioned on the first side in the axial direction with respect to the stator core 21 in a state where the slot accommodation portions 30 are accommodated in the slots 24 of the stator core 21. The slot accommodation portion 30 constitutes slot accommodation portion of the coil 26. The segment coil connection portion 31 constitutes a first coil connection portion of the coil 26. In the following description, the slot accommodation portion of the coil 26 is denoted by the same reference numeral as the slot accommodation portion 30 of the segment coil 27, and the first coil connection portion of the coil 26 is also denoted by the same reference numeral as the segment coil connection portion 31 of the segment coil 27.

In the plurality of segment coils 27, the tip of one of the pair of segment coil end portions 32 in each segment coil 27 and the tip of one of the pair of segment coil end portions 32 in the other segment coil 27 are connected by welding or the like in a state where the slot accommodation portions 30 are accommodated in the slots 24. That is, the pair of segment coil end portions 32 in each segment coil 27 is connected to the segment coil end portions 32 of the different segment coil 27. Thus, the plurality of segment coils 27 is connected in series. The U-phase coil 26u, the V-phase coil 26v, and the W-phase coil 26w are each constituted by the plurality of segment coils 27 connected in series in this manner.

In the present embodiment, the connected segment coil end portions 32 constitute a second coil connection portion 33 that connects the pair of slot accommodation portions 30 in each of the U-phase coil 26u, the V-phase coil 26v, and the W-phase coil 26w. The second coil connection portions 33 are located on the second side in the axial direction with respect to the stator core 21.

Each of the U-phase coil 26u, the V-phase coil 26v, and the W-phase coil 26w has a pair of segment coil end portions 32 that is not connected to the segment coil end portions 32 of the other segment coil 27. The segment coil end portions 32 that are not connected to the other segment coil end portions 32 in the U-phase coil 26u, the V-phase coil 26v, and the W-phase coil 26w are coil ends of the U-phase coil 26u, the V-phase coil 26v, and the W-phase coil 26w. The coil ends of the U-phase coil 26u, the V-phase coil 26v, and the W-phase coil 26w are located at one end and the other end of the coil of each phase. The coil ends of the U-phase coil 26u, the V-phase coil 26v, and the W-phase coil 26w protrude to the first side in the axial direction of the stator core 21.

Hereinafter, for the sake of description, the ends of the coil located at both ends of each of the U-phase coil 26u, the V-phase coil 26v, and the W-phase coil 26w are referred to as a first coil end 34 and a second coil end 35, respectively.

That is, the coils 26 of the present embodiment include the U-phase coil 26u, the V-phase coil 26v, and the W-phase coil 26w, and the coils 26 include the plurality of slot accommodation portions 30 positioned in the plurality of slots, the plurality of first coil connection portions 31 positioned on the first side in the axial direction with respect to the stator core 21 and connecting the slot accommodation portions 30, the plurality of second coil connection portions 33 positioned on the second side in the axial direction with respect to the stator core 21 and connecting the slot accommodation portions 30, and the first coil ends 34 and the second coil ends 35 positioned at the ends of the coils 26, extending from the slot accommodation portions 30, and protruding to the first side in the axial direction of the stator core 21.

With this configuration, a coil end portion 40 including the plurality of first coil connection portions 31 protruding from the stator core 21 to the first side in the axial direction is formed on the first side in the axial direction with respect to the stator core 21. A coil end portion including the plurality of second coil connection portions 33 protruding from the stator core 21 to the second side is formed on the second side in the axial direction with respect to the stator core 21.

In the present embodiment, all the first coil connection portions 31 are positioned on the first side in the axial direction (upper side in FIG. 2) with respect to the stator core 21, and all the second coil connection portions 33 are positioned on the second side in the axial direction (lower side in FIG. 2) with respect to the stator core 21. In addition, all the first coil ends 34 and all the second coil ends 35 are located on the first side in the axial direction where the first coil connection portions 31 are located. In the present embodiment, the coils 26 include two sets of U-phase coils 26u, V-phase coils 26v, and W-phase coils 26w. Therefore, six first coil ends 34 and six second coil ends 35 are located on the first side in the axial direction with respect to the stator core 21.

The first coil end 34 and the second coil end 35 of each of the U-phase coil 26u, the V-phase coil 26v, and the W-phase coil 26w extend from the slot accommodation portions 30 located on the radially outermost side of the slots 24 and protrude from the stator core 21. The first coil end 34 and the second coil end 35 are the segment coil end portions 32 of the segment coil 27 located on the radially outermost side of the slots 24 in the U-phase coil 26u, the V-phase coil 26v, and the W-phase coil 26w.

In the present embodiment, each of the first coil ends 34 and the second coil ends 35 are the segment coil end portions 32 of the segment coils 27 located on the radially outermost side of the slots 24. However, the first coil ends and the second coil ends may be segment coil end portions of segment coils located at positions other than the above positions.

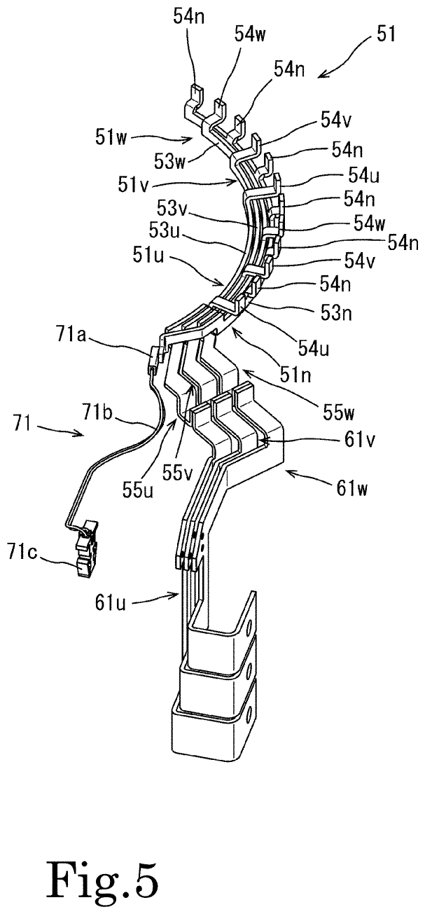

FIG. 5 is a perspective view of the busbar unit 50 from which the busbar holder 52 and an external terminal holder 62 are removed. The busbar unit 50 includes the busbars 51, the busbar holder 52, the external terminals 61, the external terminal holder 62, a temperature sensor unit 71, and the wire accommodation portion 72.

As illustrated in FIGS. 3 and 5, the busbars 51 include a U-phase busbar 51u, a V-phase busbar 51v, a W-phase busbar 51w, and a neutral point busbar 51n. Each of the U-phase busbar 51u, the V-phase busbar 51v, the W-phase busbar 51w, and the neutral point busbar 51n is a plate-shaped member. The thickness direction of each of the U-phase busbar 51u, the V-phase busbar 51v, the W-phase busbar 51w, and the neutral point busbar 51n coincides with the radial direction of the stator core 21.

As illustrated in FIG. 3, the U-phase busbar 51u, the V-phase busbar 51v, the W-phase busbar 51w, and the neutral point busbar 51n are located on the outer peripheral side of the coil end portion 40 in the radial direction in a state of partially overlapping each other in the radial direction.

As illustrated in FIG. 5, the U-phase busbar 51u includes a U-phase busbar body portion 53u, two U-phase busbar connection portions 54u, and a U-phase external terminal connection portion 55u. The U-phase busbar body portion 53u, the two U-phase busbar connection portions 54u, and the U-phase external terminal connection portion 55u are integrally formed as a single member.

The V-phase busbar 51v includes a V-phase busbar body portion 53v, two V-phase busbar connection portions 54v, and a V-phase external terminal connection portion 55v. The V-phase busbar body portion 53v, the two V-phase busbar connection portions 54v, and the V-phase external terminal connection portion 55v are integrally formed as a single member.

The W-phase busbar 51w includes a W-phase busbar body portion 53w, two W-phase busbar connection portions 54w, and a W-phase external terminal connection portion 55w. The W-phase busbar body portion 53w, the two W-phase busbar connection portions 54w, and the W-phase external terminal connection portion 55w are integrally formed as a single member.

The neutral point busbar 51n includes a neutral point busbar body portion 53n and six neutral point busbar connection portions 54n. The neutral point busbar body portion 53n and the six neutral point busbar connection portions 54n are integrally formed as a single member.

Each of the U-phase busbar body portion 53u, the V-phase busbar body portion 53v, and the W-phase busbar body portion 53w has an arc shape along the outer periphery of the coil end portion 40 when viewed in the axial direction. Each of the U-phase busbar body portion 53u, the V-phase busbar body portion 53v, and the W-phase busbar body portion 53w is positioned to overlap the first coil end 34 of the coil 26 of each phase when viewed in the radial direction of the stator core 21, and extends in the circumferential direction of the stator core 21.

Specifically, the U-phase busbar body portion 53u is positioned to overlap the first coil ends 34 of the two U-phase coils 26u when viewed in the radial direction of the stator core 21, and extends in the circumferential direction of the stator core 21. The V-phase busbar body portion 53v is positioned to overlap the first coil ends 34 of the two V-phase coils 26v when viewed in the radial direction of the stator core 21, and extends in the circumferential direction of the stator core 21. The W-phase busbar body portion 53w of the W-phase busbar 51w is positioned to overlap the first coil ends 34 of the two W-phase coils 26w when viewed in the radial direction of the stator core 21, and extends in the circumferential direction of the stator core 21.

The neutral point busbar body portion 53n of the neutral point busbar 51n has an arc shape along the outer periphery of the coil end portion 40 when viewed in the axial direction. The neutral point busbar body portion 53n is positioned to overlap the second coil ends 35 of the two U-phase coils 26u, two V-phase coils 26v, and two W-phase coils 26w when viewed in the radial direction of the stator core 21, and extends in the circumferential direction of the stator core 21. In the present embodiment, the neutral point busbar body portion 53n is longer in the circumferential direction than the U-phase busbar body portion 53u, the V-phase busbar body portion 53v, and the W-phase busbar body portion 53w.

The external terminals 61 include a U-phase external terminal 61u, a V-phase external terminal 61v, and a W-phase external terminal 61w. The U-phase external terminal 61u, the V-phase external terminal 61v, and the W-phase external terminal 61w are connected to a power supply source (not illustrated).

The U-phase external terminal connection portion 55u extends outward from one end of the U-phase busbar body portion 53u in the radial direction and is connected to the U-phase external terminal 61u. The V-phase external terminal connection portion 55v extends outward from one end of the V-phase busbar body portion 53v in the radial direction and is connected to the V-phase external terminal 61v. The W-phase external terminal connection portion 55w extends outward from one end of the W-phase busbar body portion 53w in the radial direction and is connected to the W-phase external terminal 61w.

As illustrated in FIG. 5, the two U-phase busbar connection portions 54u extend to the first side in the axial direction of the stator core 21 from the U-phase busbar body portion 53u. As illustrated in FIG. 3, the two U-phase busbar connection portions 54u are connected to the first coil ends 34 of the U-phase coils 26u.

As illustrated in FIG. 5, the two V-phase busbar connection portions 54v extend to the first side in the axial direction of the stator core 21 from the V-phase busbar body portion 53v. As illustrated in FIG. 3, the two V-phase busbar connection portions 54v are connected to the first coil ends 34 of the V-phase coils 26v.

As illustrated in FIG. 5, the two W-phase busbar connection portions 54w extend to the first side in the axial direction of the stator core 21 from the W-phase busbar body portion 53w. As illustrated in FIG. 3, the two W-phase busbar connection portions 54w are connected to the first coil ends 34 of the W-phase coils 26w.

As illustrated in FIG. 5, the six neutral point busbar connection portions 54n extend to the first side in the axial direction of the stator core 21 from the neutral point busbar body portion 53n. As illustrated in FIG. 3, the six neutral point busbar connection portions 54n are connected to the second coil ends 35 of the two sets of coils of respective phases. In the present embodiment, the second coil ends 35 are coil ends connected to the neutral point busbar 51n.

As illustrated in FIG. 5, the U-phase busbar body portion 53u, the V-phase busbar body portion 53v, the W-phase busbar body portion 53w, and the neutral point busbar body portion 53n are located on the first side in the circumferential direction of the stator core 21 with respect to the U-phase external terminal connection portion 55u, the V-phase external terminal connection portion 55v, and the W-phase external terminal connection portion 55w when viewed in the axial direction. An end of the neutral point busbar body portion 53n on the first side in the circumferential direction extends further to the first side in the circumferential direction than the U-phase busbar body portion 53u, the V-phase busbar body portion 53v, and the W-phase busbar body portion 53w.

As illustrated in FIG. 2, in the U-phase busbar 51u, the V-phase busbar 51v, the W-phase busbar 51w, and the neutral point busbar 51n, the U-phase busbar body portion 53u, the V-phase busbar body portion 53v, the W-phase busbar body portion 53w, and the neutral point busbar body portion 53n are covered by the busbar holder 52 made of resin. The busbar holder 52 has an arc shape along the U-phase busbar body portion 53u, the V-phase busbar body portion 53v, the W-phase busbar body portion 53w, and the neutral point busbar body portion 53n when viewed in the axial direction. The busbar holder 52 serves as a resin portion that is made of a resin material and that covers at least a part of the busbars 51.

In the present embodiment, the U-phase coils 26u, the V-phase coils 26v, and the W-phase coils 26w are Y-connected by the U-phase busbar 51u, the V-phase busbar 51v, the W-phase busbar 51w, and the neutral point busbar 51n.

Specifically, the first coil ends 34 of the U-phase coils 26u are connected to the U-phase busbar connection portions 54u of the U-phase busbar 51u. The first coil ends 34 of the V-phase coils 26v are connected to the V-phase busbar connection portions 54v of the V-phase busbar 51v. The first coil ends 34 of the W-phase coils 26w are connected to the W-phase busbar connection portions 54w of the W-phase busbar 51w. Further, the six second coil ends 35 of the U-phase coils 26u, the V-phase coils 26v, and the W-phase coils 26w are connected to the neutral point busbar 51n.

Thus, the stator 2 can be obtained in which the U-phase coils 26u, the V-phase coils 26v, and the W-phase coils 26w wound around the stator core 21 are Y-connected by the U-phase busbar 51u, the V-phase busbar 51v, the W-phase busbar 51w, and the neutral point busbar 51n.

The temperature sensor unit 71 measures the temperature of the neutral point busbar 51n. Specifically, as illustrated in FIG. 5, the temperature sensor unit 71 is attached to a first end of the neutral point busbar 51n in the circumferential direction, and measures the temperature of the end.

The temperature sensor unit 71 includes a temperature sensor 71a, a wire 71b, and a temperature sensor connector 71c.

The temperature sensor 71a is physically in contact with the first end of the neutral point busbar 51n in the circumferential direction. Specifically, the temperature sensor 71a is located near a connection portion between the U-phase busbar body portion 53u and the U-phase external terminal connection portion 55u, a connection portion between the V-phase busbar body portion 53v and the V-phase external terminal connection portion 55v, and a connection portion between the W-phase busbar body portion 53w and the W-phase external terminal connection portion 55w.

The temperature sensor 71a includes a temperature element capable of measuring the temperature of the neutral point busbar 51n. The temperature sensor 71a outputs the temperature of the neutral point busbar 51n detected by the temperature element as a temperature detection signal. The structure of the temperature element is similar to that of a conventional temperature element, so that the detailed description thereof will be omitted.

The wire 71b is connected to the temperature sensor 71a on one side. The wire 71b is connected to the temperature sensor connector 71c on the other side. The wire 71b extends outward in the radial direction of the stator 2 from the temperature sensor 71a. The temperature sensor connector 71c is connected to an external device (not illustrated). That is, the wire 71b outputs the temperature detection signal output from the temperature sensor 71a to the outside of the stator 2.

As described above, in the present embodiment, the neutral point busbar 51n extends in the circumferential direction of the stator core 21. The temperature sensor 71a is in contact with an end of the neutral point busbar 51n in the longitudinal direction. With this configuration, the wire 71b connected to the temperature sensor 71a in contact with the neutral point busbar 51n can be easily extracted to the outside of the stator 2.

In the present embodiment, the busbars 51 include the neutral point busbar 51n to which the coil ends of the three-phase coils are connected. The temperature sensor 71a is in contact with the neutral point busbar 51n. Thus, in the stator 2 having Y-connection, the temperature of the neutral point busbar 51n can be easily measured by the temperature sensor 71a.

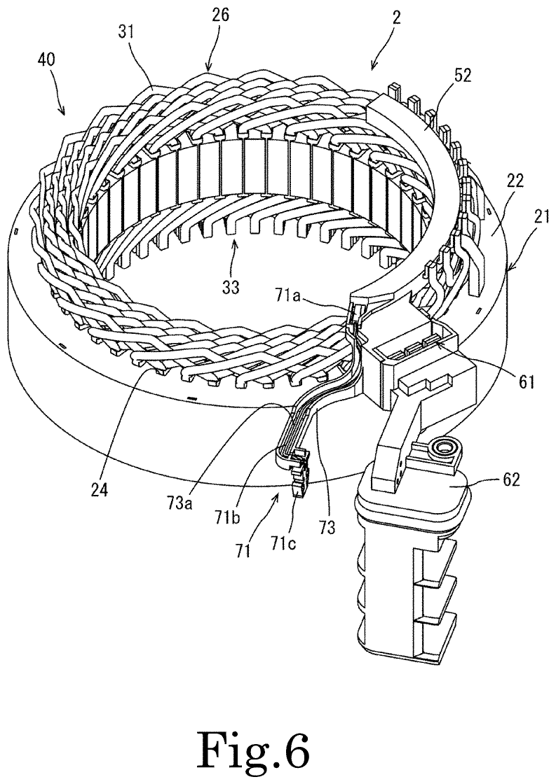

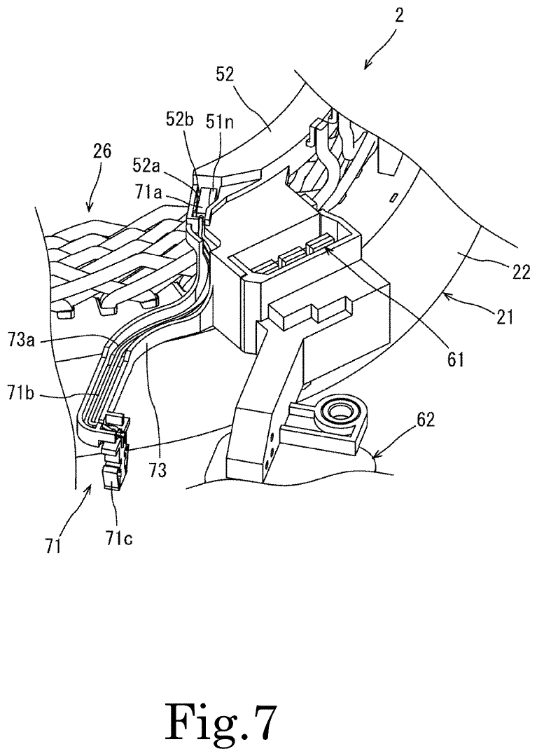

FIG. 6 is a perspective view illustrating a state in which a cover 74 of the wire accommodation portion 72 described later is removed from the busbar unit 50. FIG. 7 is a partially enlarged view of the temperature sensor unit 71 in FIG. 6 in an enlarged manner.

As illustrated in FIG. 7, the temperature sensor 71a is accommodated in a recess 52a formed in the end of the busbar holder 52. The recess 52a exposes the first end of the neutral point busbar 51n in the circumferential direction.

The recess 52a has, on its inner surface, a protrusion 52b that presses the temperature sensor 71a in the thickness direction of the neutral point busbar 51n against the first end of the neutral point busbar 51n in the circumferential direction. That is, the protrusion 52b protrudes from the inner surface of the recess 52a toward the neutral point busbar 51n. As a result, the temperature sensor 71a can be more reliably brought into contact with the neutral point busbar 51n while being fixed to the busbar holder 52.

As described above, in the present embodiment, the busbar holder 52 has the recess 52a. The temperature sensor 71a is fixed to the busbar holder 52 in a state of being accommodated in the recess 52a. Accordingly, the temperature sensor 71a can be disposed compactly with respect to the busbars 51 and the busbar holder 52.

The wire 71b is covered with the wire accommodation portion 72. The wire accommodation portion 72 extends from the busbar holder 52 to the side opposite to the busbars 51 when viewed in the axial direction. That is, the wire accommodation portion 72 is connected to the busbar holder 52 and extends radially outward and toward the first side in the circumferential direction. Similar to the busbar holder 52, the wire accommodation portion 72 is made of resin.

The wire accommodation portion 72 is formed integrally with the busbar holder 52 as a single member, and includes: a wire accommodation case 73 which is made of resin and which has a groove 73a capable of accommodating the wire 71b; and the cover 74 covering the groove 73a. The wire 71b accommodated in the groove 73a of the wire accommodation case 73 is covered with the cover 74, whereby the wire 71b connected to the temperature sensor 71a is covered with the wire accommodation portion 72. In addition, the wire 71b is accommodated in the wire accommodation case 73 without being sealed with resin, whereby the temperature sensor unit 71 can be easily replaced.

As described above, the stator unit 10 according to the present embodiment includes: the cylindrical stator core 21 having the plurality of slots 24 arranged in the circumferential direction on the inner peripheral surface; the plurality of coils 26u, 26v, and 26w inserted into the slots 24; the plurality of busbars 51u, 51v, 51w, and 51n connected to the plurality of coils 26u, 26v, and 26w; the busbar holder 52 made of a resin material and covering at least a part of the plurality of busbars 51u, 51v, 51w, and 51n; and the temperature sensor 71a that is fixed while in contact with at least one busbar 51n among the plurality of busbars 51u, 51v, 51w, and 51n and measures the temperature of the at least one busbar 51n.

With this configuration, the temperature sensor 71a is fixed to the busbar holder 52 that covers at least a part of the busbar 51n in a state of being in contact with the busbar 51n. As a result, the temperature sensor 71a that measures the temperature of the busbar 51n can be easily mounted.

In the present embodiment, the motor 1 includes the stator unit 10 having the abovementioned configuration, and the rotor 3 rotatable about the central axis P with respect to the stator 2 of the stator unit 10. As a result, it is possible to obtain the motor 1 in which the temperature sensor 71a that measures the temperature of the busbar 51n can be easily mounted.

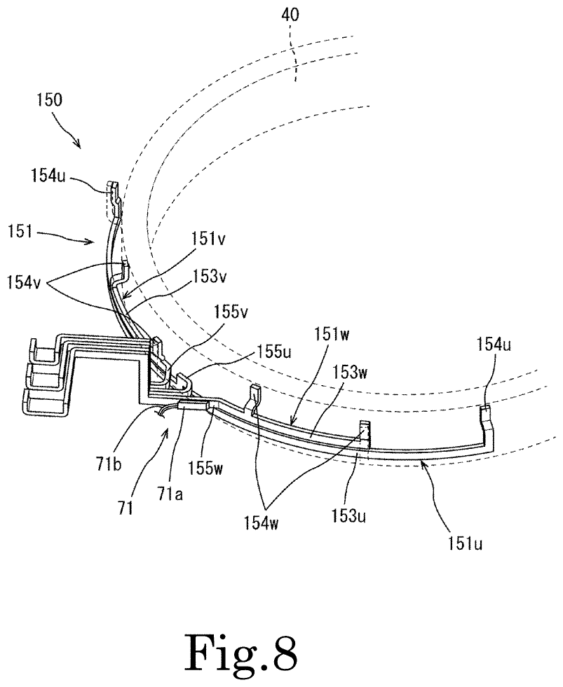

FIG. 8 illustrates a schematic configuration of a busbar unit 150 of a stator unit according to a second embodiment. FIG. 8 illustrates a state where a busbar holder and external terminals are removed from the busbar unit 150. The busbar unit 150 according to the second embodiment is different from the busbar unit in the first embodiment in the method for connecting a stator to coils. Therefore, the configurations of busbars 151 of the busbar unit 150 are different from those of the first embodiment. The attachment position of a temperature sensor 71a with respect to the busbars 151 is different from the attachment position in the first embodiment.

In the following, the same components as those in the first embodiment will be designated by the same reference numerals and the description thereof will be omitted. Only the parts different from those in the first embodiment will be described.

The busbar unit 150 includes the busbars 151, the busbar holder (not illustrated), and the external terminals (not illustrated). The configuration of the busbar holder is similar to that in the first embodiment regarding covering the busbars 151, and thus the detailed description thereof will be omitted. Further, the external terminals are similar in configuration to those in the first embodiment, and thus, the detailed description thereof will be omitted.

The busbars 151 include a U-phase busbar 151u, a V-phase busbar 151v, and a W-phase busbar 151w. Each of the U-phase busbar 151u, the V-phase busbar 151v, and the W-phase busbar 151w is a plate-like member. The thickness direction of each of the U-phase busbar 151u, the V-phase busbar 151v, and the W-phase busbar 151w coincides with the radial direction of the stator core 21.

The U-phase busbar 151u includes a U-phase busbar body portion 153u, two U-phase busbar connection portions 154u, and a U-phase external terminal connection portion 155u. The U-phase busbar body portion 153u, the two U-phase busbar connection portions 154u, and the U-phase external terminal connection portion 155u are integrally formed as a single member.

The V-phase busbar 151v includes a V-phase busbar body portion 153v, two V-phase busbar connection portions 154v, and a V-phase external terminal connection portion 155v. The V-phase busbar body portion 153v, the two V-phase busbar connection portions 154v, and the V-phase external terminal connection portion 155v are integrally formed as a single member.

The W-phase busbar 151w includes a W-phase busbar body portion 153w, two W-phase busbar connection portions 154w, and a W-phase external terminal connection portion 155w. The W-phase busbar body portion 153w, the two W-phase busbar connection portions 154w, and the W-phase external terminal connection portion 155w are integrally formed as a single member.

Each of the U-phase busbar body portion 153u, the V-phase busbar body portion 153v, and the W-phase busbar body portion 153w has an arc shape along the outer periphery of a coil end portion 40 when viewed in the axial direction. Although not particularly illustrated, the U-phase busbar body portion 153u, the V-phase busbar body portion 153v, and the W-phase busbar body portion 153w are positioned to overlap first coil ends 34 of coils 26 of the respective phases when viewed in the radial direction of the stator core 21, and extend in the circumferential direction of the stator core 21.

The U-phase busbar body portion 153u is longer in the circumferential direction than the V-phase busbar body portion 153v and the W-phase busbar body portion 153w.

The U-phase external terminal connection portion 155u extends outward from a position other than both ends of the U-phase busbar body portion 153u in the radial direction. The V-phase external terminal connection portion 155v extends outward from one end of the V-phase busbar body portion 153v in the radial direction. The W-phase external terminal connection portion 155w extends outward from one end of the W-phase busbar body portion 153w in the radial direction.

The U-phase external terminal connection portion 155u, the V-phase external terminal connection portion 155v, and the W-phase external terminal connection portion 155w are respectively connected to the external terminals (not illustrated). The temperature sensor 71a to be described later is in contact with the W-phase external terminal connection portion 155w.

The U-phase busbar 151u, the V-phase busbar 151v, and the W-phase busbar 151w are positioned on the outer peripheral side of the coil end portion 40 in the radial direction in a state of partially overlapping with each other in the radial direction or the axial direction.

As illustrated in FIG. 8, the U-phase external terminal connection portion 155u, the V-phase external terminal connection portion 155v, and the W-phase external terminal connection portion 155w partially overlap each other in the thickness direction.

The W-phase busbar body portion 153w of the W-phase busbar 151w is located on the first side in the circumferential direction with respect to the U-phase external terminal connection portion 155u of the U-phase busbar 151u. The V-phase busbar body portion 153v of the V-phase busbar 151v is located on the second side in the circumferential direction with respect to the U-phase external terminal connection portion 155u of the U-phase busbar 151u. The V-phase external terminal connection portion 155v and the W-phase external terminal connection portion 155w are arranged in the circumferential direction across the U-phase external terminal connection portion 155u.

A part of the U-phase busbar body portion 153u of the U-phase busbar 151u overlaps the W-phase busbar body portion 153w of the W-phase busbar 151w and the V-phase busbar body portion 153v of the V-phase busbar 151v when viewed in the axial direction.

In the present embodiment, the U-phase coil 26u, the V-phase coil 26v, and the W-phase coil 26w are A-connected by the U-phase busbar 151u, the V-phase busbar 151v, and the W-phase busbar 151w.

Specifically, the first coil end 34 of the U-phase coil 26u is connected to the U-phase busbar connection portion 154u of the U-phase busbar 151u. The first coil end 34 of the V-phase coil 26v is connected to the V-phase busbar connection portion 154v of the V-phase busbar 151v. The first coil end 34 of the W-phase coil 26w is connected to the W-phase busbar connection portion 154w of the W-phase busbar 151w.

A second coil end 35 of the U-phase coil 26u is connected to the V-phase busbar connection portion 154v of the V-phase busbar 151v. The second coil end 35 of the V-phase coil 26v is connected to the W-phase busbar connection portion 154w of the W-phase busbar 151w. The second coil end 35 of the W-phase coil 26w is connected to the U-phase busbar connection portion 154u of the U-phase busbar 151u.

As a result, the stator can be obtained in which the U-phase coil 26u, the V-phase coil 26v, and the W-phase coil 26w wound around the stator core 21 are A-connected by the U-phase busbar 151u, the V-phase busbar 151v, and the W-phase busbar 151w.

In the present embodiment, the first coil end 34 and the second coil end 35 correspond to a coil end connected to the busbars 151.

In the present embodiment, the temperature sensor 71a of a temperature sensor unit 71 is physically in contact with the W-phase external terminal connection portion 155w of the W-phase busbar 151w. That is, in the present embodiment, the temperature sensor 71a measures the temperature of the W-phase busbar 151w.

The configuration of the temperature sensor unit 71 is similar to that of the first embodiment. Therefore, the description of the configuration of the temperature sensor unit 71 will be omitted.

The temperature sensor 71a is accommodated in the busbar holder (not illustrated). As in the first embodiment, a wire 71b of the temperature sensor unit 71 is accommodated in a wire accommodation portion made of resin. The configuration of the wire accommodation portion is also similar to that of the wire accommodation portion 72 in the first embodiment.

As described above, in the present embodiment, the busbars 151 are connected to the coil ends of coils of two phases among the coils 26 of three phases. In such a stator unit having A-connection, the temperature of the busbar 151 can be easily measured by bringing the temperature sensor 71a into contact with the busbar 151 as in the present embodiment.

In addition, the W-phase busbar 151w includes a W-phase busbar body portion 153w extending in the circumferential direction of the stator core, and a W-phase busbar connection portion 154w extending outward in the radial direction of the stator core from the W-phase busbar body portion 153w and electrically connected to a power supply source. The temperature sensor 71a is in contact with a connection portion between the W-phase busbar body portion 153w and the W-phase busbar connection portion 154w of the W-phase busbar 151w.

In general, in the busbar, the temperature of a connection portion between a busbar body portion and a busbar connection portion electrically connected to the power supply source is the highest. Therefore, by measuring the temperature of the connection portion by the temperature sensor 71a, the temperature rise of the stator can be accurately detected.

In the present embodiment, the temperature sensor 71a is in contact with the W-phase busbar 151w to measure the temperature of the W-phase busbar 151w, but may be in contact with the U-phase busbar 151u or the V-phase busbar 151v to measure the temperature of the U-phase busbar 151u or the V-phase busbar 151v. Further, the temperature sensor 71a may measure temperatures of a plurality of busbars. Further, the temperature sensor 71a may measure the temperature at a plurality of positions of the busbar.

While the embodiments of the present invention have been described above, the above embodiments are merely examples for implementing the present invention. Thus, the present invention is not limited to the embodiments described above, and the embodiments described above may be appropriately modified and implemented without departing from the scope of the present invention.

In each of the above embodiments, the coils 26 include coils of three phases. However, the coils may include multi-phase coils other than three-phase coils.

In each of the above embodiments, the coils 26 include two sets of coils of three phases. However, the coils may include one set or three or more sets of three-phase coils.

In each of the above embodiments, all the first coil connection portions 31 are located on the first side in the axial direction with respect to the stator core 21, and all the second coil connection portions 33 are located on the second side in the axial direction with respect to the stator core 21. However, all the first coil connection portions may be located on the second side in the axial direction with respect to the stator core. All the second coil connection portions may be located on the first side in the axial direction with respect to the stator core. A part of the first coil connection portions may be located on the first side in the axial direction with respect to the stator core. A part of the second coil connection portions may be located on the second side in the axial direction with respect to the stator core. A part of the first coil connection portions may be located on the second side in the axial direction with respect to the stator core. A part of the second coil connection portions may be located on the first side in the axial direction respect to the end of the stator core.

In each of the above embodiments, the first coil ends 34 and the second coil ends 35 are located on the side where the first coil connection portions 31 are located in the axial direction with respect to the stator core 21. However, the first coil ends may be located on either the first side or the second side in the axial direction with respect to the stator core. In addition, the second coil ends may be located on either the first side or the second side in the axial direction with respect to the stator core.

In the first embodiment, the U-phase busbar body portion 53u, the V-phase busbar body portion 53v, the W-phase busbar body portion 53w, and the neutral point busbar body portion 53n of the busbars 51 are covered by the busbar holder 52 made of resin. However, the busbars may be entirely covered by the busbar holder.

In the first embodiment, the U-phase busbar body portion 53u, the V-phase busbar body portion 53v, the W-phase busbar body portion 53w, and the neutral point busbar body portion 53n of the busbars 51 are covered by the busbar holder 52 made of resin. Further, although not particularly illustrated, the busbars 151 are also covered with the busbar holder in the second embodiment. However, the busbars may be molded with resin instead of the busbar holder. In this case, the temperature sensor that measures the temperature of the busbar may also be molded with resin. While the busbars are molded with resin, the temperature sensor may be accommodated in a case made of resin.

In the first embodiment, the temperature sensor 71a measures the temperature of the neutral point busbar 51n. However, the temperature sensor may measure the temperature of another busbar. In addition, the temperature sensor may measure temperatures of a plurality of busbars. In addition, the temperature sensor may measure the temperature at a plurality of positions of the busbar.

In each of the above embodiments, the stator core 21 has a cylindrical shape. However, the stator core may have a shape other than the cylindrical shape as long as the stator core is tubular.

In each of the above embodiments, the motor 1 is a so-called inner rotor type motor in which the rotor 3 is located so as to be rotatable about the central axis P in the tubular stator 2. However, the motor may be a so-called outer rotor type motor in which a stator is located in a tubular rotor. In this case, the stator has a plurality of slots arranged in the circumferential direction on the outer peripheral surface.

The first embodiment describes a configuration example of busbars that achieves Y-connection of the stator 2. However, the busbars may have another configuration as long as they can achieve Y-connection of the stator.

The second embodiment describes a configuration example of busbars that achieves A-connection of the stator. However, the busbars may have another configuration as long as they can achieve A-connection of the stator.

The present invention can be applied to a stator unit having a busbar that is at least partially covered with a resin portion.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A stator unit comprising:
a stator core that is cylindrical and has a plurality of slots arranged in a circumferential direction on an inner peripheral surface or an outer peripheral surface;
a plurality of coils inserted into the slots;
a plurality of busbars connected to the plurality of coils;
a resin portion made of a resin material and covering at least a part of the plurality of busbars; and
a temperature sensor that is fixed to the resin portion while in contact with at least one busbar among the plurality of busbars, the temperature sensor measuring a temperature of the at least one busbar.

2. The stator unit according to claim 1, wherein
the plurality of busbars extends in the circumferential direction of the stator core, and
the temperature sensor is in contact with an end of the at least one busbar in a longitudinal direction.

3. The stator unit according to claim 1, wherein
the plurality of busbars includes a neutral point busbar to which coil ends of the plurality of coils are connected, and
the temperature sensor is in contact with the neutral point busbar.

4. The stator unit according to claim 1, wherein
the plurality of busbars is connected to coil ends of coils of two phases among the plurality of coils.

5. The stator unit according to claim 1, wherein
each of the plurality of busbars includes:
a busbar body portion extending in the circumferential direction of the stator core; and
a busbar connection portion extending outward in a radial direction of the stator core from the busbar body portion and electrically connected to a power supply source, and
the temperature sensor is in contact with a connection portion between the busbar body portion and the busbar connection portion.

6. The stator unit according to claim 1, wherein
the resin portion has a recess, and
the temperature sensor is fixed to the resin portion in a state of being accommodated in the recess.

7. The stator unit according to claim 1, further comprising:
a wire accommodation case that is made of resin and is formed integrally with the resin portion as a single member, the wire accommodation portion having a groove capable of accommodating a wire connected to the temperature sensor; and
a cover that covers the groove.

8. A motor comprising:
the stator unit according to claim 1; and
a rotor rotatable about a central axis with respect to a stator of the stator unit.
